(19) United States
(12) Patent Application Publication
(10) Pub. No.: US 2014/0086242 A1
(43) Pub. Date: Mar. 27, 2014

(54) DEVICE FOR TRANSMITTING SIGNALS FROM A VEHICLE

(71) Applicant: Drew Technologies, Inc., Ann Arbor, MI (US)

(72) Inventors: Michael Drew, Dexter, MI (US); Brian Herron, Dexter, MI (US)

(73) Assignee: Drew Technologies, Inc., Ann Arbor, MI (US)

(21) Appl. No.: 14/018,754

(22) Filed: Sep. 5, 2013

Related U.S. Application Data
(60) Provisional application No. 61/697,071, filed on Sep. 5, 2012.

(51) Int. Cl. H04L 12/781; H04L 29/06

(52) U.S. Cl. CPC H04L 45/52; H04L 69/08
USPC 370/389

(57) ABSTRACT

The device for transmitting signals from a vehicle may include a controller, a first connector, a second connector, a third connector, and a fourth connector. The controller is in communication each of the connectors. The first connector includes a first connector type, which may be a male J1962 connector type, and is configured of transmitting more of a plurality of signals there through. The second connector includes a second connector type, which may be a female J1962 connector type, and is configured to transmit one of the plurality of signals there through. The third connector includes a third connector type, which may be an RJ45 jack, and is configured to transmit one of the plurality of signals there through. The fourth connector includes a fourth connector type, which may be a universal serial bus connector type, and is configured to send and receive the commands to/from the controller.

### CROSS REFERENCE TO RELATED APPLICATION

This application claims the benefit of U.S. provisional application entitled VEHICLE ETHERNET BREAKOUT BOX, application No. 61/697,071 filed on Sep. 5, 2012.

### BACKGROUND

1. Field of the Invention

The invention relates to devices for transmitting signals from a vehicle.

2. Description of Related Art

In recent years, vehicles include a connector port that allows external devices to communicate with one or more electronic control units (“ECUs”) of the vehicle. For example, passenger vehicles and light truck vehicles sold in the United States generally include a vehicle connector referred to as a J1962 connector, sometimes also referred to as an OBD II port. The J1962 connector refers to a standard set by the Society of Automotive Engineers (“SAE”), which approved the J1962 connector and related hardware and software.

Utilizing the J1962 connector allows vehicle original equipment manufacturers (“OEMS”) and third parties to communicate with one or more of the ECUs of the vehicle using an external device, such as a scan tool. The communication path through the J1962 connector allows devices manufactured and/or sold by OEMs and third parties to perform numerous vehicle services including, but not limited to, diagnostics, reprogramming, data logging, and bus monitoring.

For example, with regards to diagnostics, an external device may be connected to the J1962 connector. This external device retrieves diagnostic related information from the vehicle to allow a speedier repair process of the vehicle. Further, as regards to reprogramming, the J1962 port may be utilized by an external device, which may also perform diagnostics as described above, to perform reprogramming of the ECU to allow the upgrading of firmware or engine calibrations or other calibrations of the vehicle.

The J1962 connector is usually a sixteen pin connector that includes pins that are not utilized. These unutilized pins may be used for a variety of different applications. For example, some vehicle OEMs may use some of these unutilized connector pins as transmission and/or receiver lines for communicating Ethernet transmission protocol data. However, one drawback of communicating Ethernet protocol data using the J1962 connector is that the physical shape of the J1962 connector is not compatible with common Ethernet cabling and jacks, such as the RJ45 jack. Therefore, one must utilize a larger and more expensive cabling compatible with the J1962 connector in order to access Ethernet protocol data from the pins of the J1962 connector. Further complicating matters, common personal computers (“PCs”), such as Windows based PCs rarely, if ever, have a port that is compatible with the J1962 connector.

### SUMMARY

The device for transmitting signals from a vehicle may include a controller, a first connector, a second connector, a third connector, and a fourth connector. The controller is in communication with each of the connectors. The first connector includes a first connector type, which may be a male J1962 connector type, and is configured to transmit a plurality of signals there through. The second connector includes a second connector type, which may be a female J1962 connector type, and is configured to transmit one of the plurality of signals therethrough. The third connector includes a third connector type, which may be an RJ45 jack, and is configured to transmit one of the plurality of signals there through. The fourth connector includes a fourth connector type, which may be a universal serial bus (“USB”) connector type, and is configured to send and receive the commands to/from the controller.

The controller is configured to route one of the plurality of signals transmitted through the first connector to the second connector and/or third connector depending on the type of signal being transmitted through the first connector. For example, the third connector, which may be an RJ45 jack, may receive Ethernet protocol based signals from the first connector and second connector may receive more standard vehicle protocol signals. Of course, it should be understood, that any combination of signals from the first connector may be transmitted to the second and/or third connector.

Further objects, features, advantages and embodiments of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a block diagram of a system utilizing a device for transmitting signals from a vehicle; and

FIG. 2 illustrates a more detailed block diagram of the device for transmitting signals from a vehicle of FIG. 1.

### DETAILED DESCRIPTION

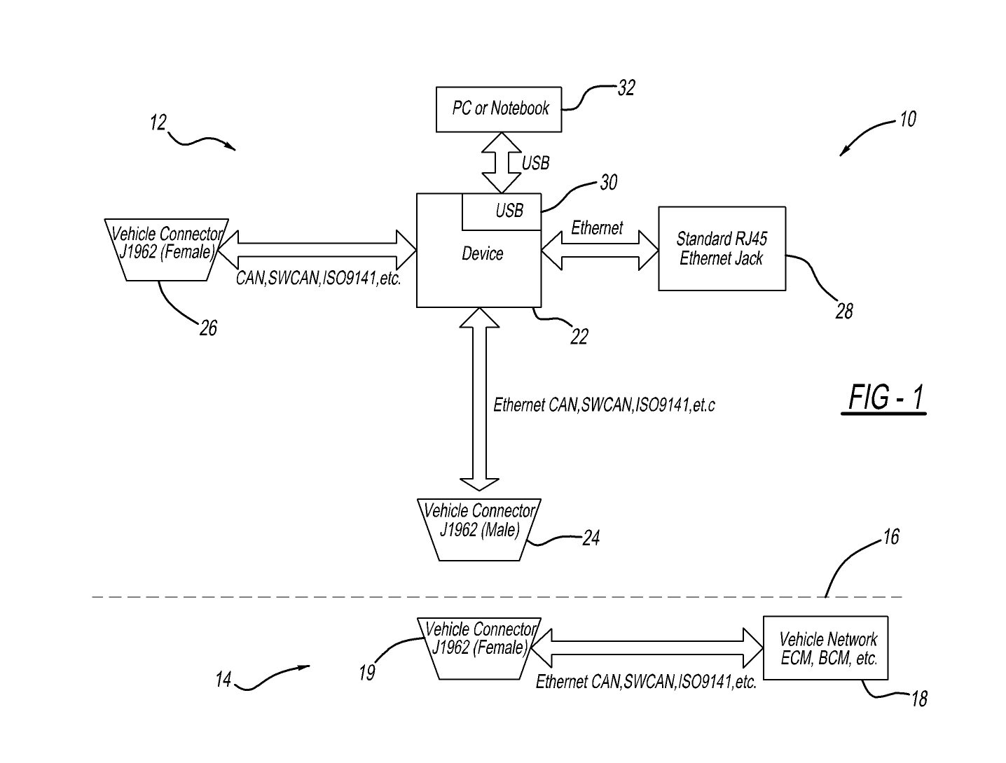

FIG. 1 illustrates a system 10 having a device 12 for transmitting signals from a vehicle 14. In order to better illustrate the system 10, the device 12 is shown to be separated from the vehicle 14 as indicated by line 16. The vehicle 14 includes a vehicle network 18. The vehicle network 18 may be a controller area network (“CAN”) commonly found in vehicles, but may be any suitable network for a vehicle, such as Ethernet, single wire control area network (“SWCAN”), or International Standard Organization (“ISO”) 1941.

The vehicle network 18 may be connected to a variety of different ECUs found on the vehicle. Further, the ECU may be part of a greater system that is dedicated to controlling the engine, transmission, brakes, and other safety systems of the vehicle. The vehicle network 18 is also in communication with a vehicle connector 19. The vehicle connector 19 allows bi directional communication with vehicle network 18 with the device 12 via a cable. While any number of different connector types may be utilized, the vehicle connector 19 may be a female J1962 connector, sometimes referred to as an OBD II port.

Referring to the device 12 for transmitting signals, the device 12 may have a housing 22. The device 12 may also include a first connector 24, a second connector 26, a third connector 28, and a fourth connector 30 supported by the housing 22. The first connector 24 may be a male J1962 connector that is configured to mate with the vehicle connector 19. For example, the first connector 24 may be a male J1962 connector, while the vehicle connector 19 may a female J1962 connector. As such, using the appropriate cabling, the first connector 24 may be placed in electrical communication with the vehicle connector 19. The vehicle connector 19 may then communicate with a controller of the device 12 for transmitting signals using a variety of different standards, such as Ethernet, CAN, SWCAN, ISO9141, or any other suitable network.

Turning our attention to the second connector 26, the second connector 26 may communicate with the controller of the device 12 utilizing a variety of different networks, such as CAN, SWCAN, ISO9141, or any other suitable network. As to the third connector 28, the third connector 28 may be an RJ45 Ethernet jack that communicates with the controller of the device 12 using Ethernet protocol standard.

As to the fourth connector 30, this connector may be a USB type connector that can be connected to an external device, such as a personal computer 32. As well known, personal computers 32 commonly include a USB port that allows communication with other USB devices using the appropriate USB cabling. As will be explained later in the Specification, the personal computer 32 is capable of communicating with the device 12 via USB connector 30. The personal computer 32 will be able to dictate by programming the controller of the device 12 which signals are received by the first connector port 24 are to be sent to the second connector 26 or the third connector 28.

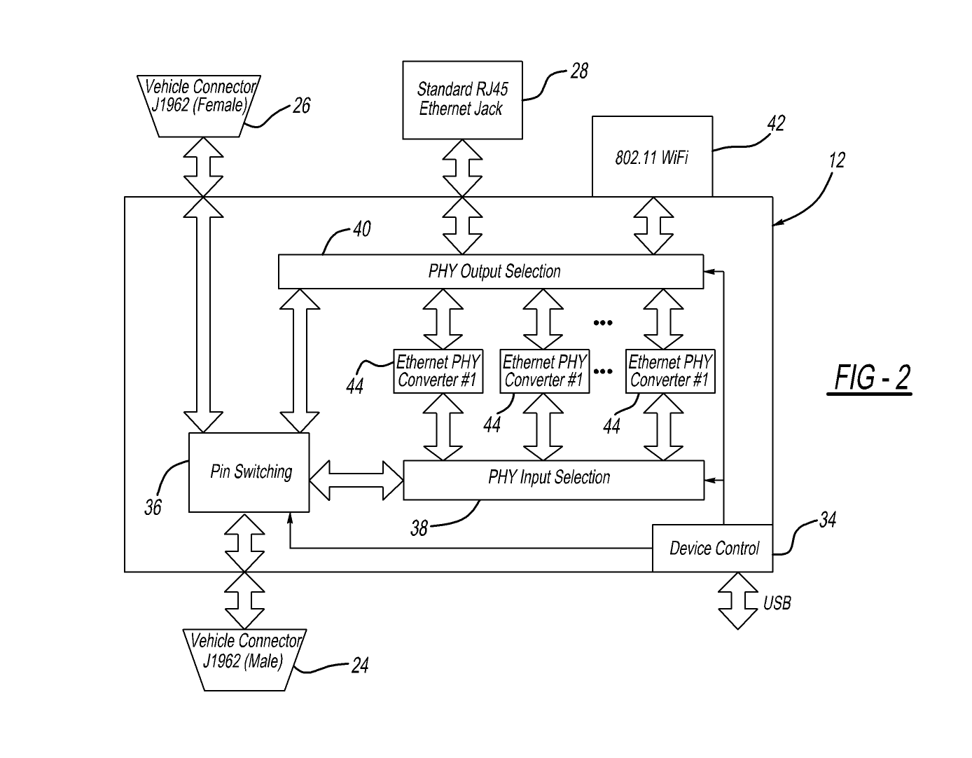

Referring to FIG. 2, a more detailed illustration of the device 12 for transmitting signals is shown. In additional to the elements previously mentioned when describing FIG. 1, the device 12 includes the controller 34. The controller 34 may be one of any number of commonly utilized microcontrollers. These microcontrollers may include a 68HC11 or other suitable microcontrollers. The controller 34 may be in communication with the personal computer 32 of FIG. 1.

The controller 34 is in communication with a pin switching device 36, an input selection device 38, and an output selection device 40. As to the pin switching device 36, the pin switching device 36 is in communication with the first connector 24, second connector 26, the input selection device 38, the output selection device 40.

Based on signals received from the controller 24, the pin switching device 36 allows information received from the pins of the first connector 24 to be communicated to the second connector 26. For example, it may be possible that all the signals received from the first connector 24 may be communicated to the second connector 26 or perhaps a subset of the signals. In another example, it may be possible that Ethernet related signals from the first connector 24 may be removed, allowing only the non-Ethernet related signals to be communicated to the second connector 26. More specifically, the protocol utilized by the first connector 26 maybe non-standard Ethernet and a second protocol utilized by the third connector 28 comprises 802.3 100 baseT Ethernet

By so doing, this allows signals received from the first connector 24 to still be received to a device connected to the second connector 26, essentially allowing only the signals that the user of the device 12 desires to be transferred to the second connector 26 from the first connector 24. The pin switching device 34 may also receive instructions regarding which inputs received from the first connector 24 to provide to the second connector 26 from the input selection device 38. As stated previously, the input selection device 38 is connected to controller 34 which would dictate which signals are to be transferred from the first connector 24 to the second connector 26.

Further, the pin switching device 34 may also be instructed to send signals to the output selection device 40. The output selection device 40 could then relay these signals either directly or in multiplexing type manner to the third connector 28 or even to a wireless communication device 42 such as an IEEE 802.11 type transceiver. This functionality allows signals received from the first connector 24 to be communicated either directly to the second connector 26, third connector 28 or the wireless communication device 42.

Determining which signals are to be sent to the second connector 26, third connector 28 or the wireless communication device 42 can be done by programming the controller 34 using the PC 32. This allows the user of the device 12 the flexibility in determine which signals should be sent to which connectors. It should be understood that the controller 34 can be programmed by the PC 32 once and then function as programmed without having the device 12 connected to the PC 32. Further, the controller 34 device 12 may also be programmed at the point of manufacture without the need for the user to program the device 12 using the PC 32.

As stated previously, the input selection device 38 is in communication with the controller 34 as well as the pin switching device 36. The controller 34 directs the input selection device 38 as to which signals to send to the output selection device 40. The input selection device 38 may be connected to one or more Ethernet converters 44 which allow information to be converted to an Ethernet protocol. Information that has been converted to an Ethernet protocol can then been provided to the output selection device 40. The output selection device 40 can then route information from the Ethernet converter 44 and/or pin switching device 36 to the third connector 28, which was previously mentioned as being an RJ45 Ethernet jack. Additionally, the output selection device 40 could also route this information to a wireless transmitter, such as the wireless communication device 42.

When configured as described above, the device 12 can allow information provided to the pins of the first connector 24 to be routed in a variety of different ways to the second connector 26 and/or third connector 28. For example, if some of the pins of vehicle connector 24 are dedicated to transmit the Ethernet related information, the controller 34 can utilize the pin switching device 26, input selection device 36, and output selection device 40 to provide Ethernet related information to the third connector 28 and the non-Ethernet related information to the second connector 26. Further, controller 34 could simply pass information received by the first connector 24 directly on to the second connector 26. Additionally, the controller 34 could also multiplex all or some of the information received by the first connector 24 and output this information to the third connector 28 and/or the wireless transmitter 38.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A device for transmitting signals from a vehicle, the device comprising:
a controller;
a first connector operatively coupled to the controller, the first connector including a first connector type and capable of transmitting one of a plurality of vehicle protocol signals therethrough;
a second connector operatively coupled to the controller, the second connector including a second connector type and configured to transmit one of the plurality of signals therethrough;
a third connector operatively coupled to the controller, the third connector including a third connector type and configured to transmit one of the plurality of signals therethrough;
wherein the device routes the one of the plurality of signals transmitted through the first connector to one of the second connector or the third connector depending on the type of vehicle protocol signal being transmitted through the first connector.

2. The device of claim 1, further comprising a fourth connector operatively coupled to the controller, the fourth connector including a fourth connector type and configured to send and receive commands from the controller.

3. The device of claim 2, wherein the device converts the vehicle protocol signal transmitted through the first connector from a first protocol to a second protocol.

4. The device of claim 2, wherein the first protocol comprises non-standard Ethernet and the second protocol comprises 802.3 100 baseT Ethernet.

5. The device of claim 2, wherein the first protocol comprises wired Ethernet and the second protocol comprises 802.11 wireless Ethernet.

6. The device of claim 2, further comprising a pin switcher disposed between the first connector and the second connector and also between the first connector and the third connector.

7. The device of claim 1, wherein the first connector type comprises a J1962 male connector.

8. The device of claim 1, wherein the second connector type comprises a RJ45 Ethernet connector.

9. The device of claim 1, wherein the third connector type comprises a J1962 female connector.

10. The device of claim 2, wherein the fourth connector comprises a USB connector.

11. The device of claim 1, further comprising an 802.11 wireless radio operatively coupled to the controller and configured to transmit an output signal.

12. The device of claim 7, wherein the pin switcher is configured to selectively route signals from the first connector to at least one of the second connector or third connector.

13. The device of claim 12, wherein the first connector includes a plurality of pins, and the pin switcher selects a first subset of pins corresponding to a predetermined signal protocol to route the signal from the first connector to the third connector.

14. The device of claim 12, wherein the first connector includes a plurality of pins, and the pin switcher selects a first subset of pins corresponding to a predetermined signal protocol to route the signal from the first connector to the second connector.

15. The device of claim 14, further comprising an Ethernet converter, and the signal is routed from the first connector to the second connector via the Ethernet converter.

16. The device of claim 15, wherein the Ethernet converter comprises a input selector and a output selector that are coupled to the controller for converting an Ethernet signal input from the first connector to an Ethernet signal output for the second connector.

17. The device of claim 16, wherein the Ethernet converter further comprises a plurality of Ethernet convertors corresponding to a plurality of Ethernet conversion algorithms.

18. A device for transmitting signals from a vehicle, the device comprising:
a controller;
a first connector operatively coupled to the controller, the first connector including a first connector type and capable of transmitting one of a plurality of vehicle protocol signals therethrough;
a second connection operatively coupled to the controller, the second connection configured to transmit one of the plurality of signals therethrough;
wherein the device routes the one of the plurality of signals transmitted through the first connector to one of the second connection depending on the type of vehicle protocol signal being transmitted through the first connector; and
wherein the first connector type is a J1962 connector and the second connection is an Ethernet protocol connection type.

19. The device for transmitting signals from a vehicle of claim 18, wherein the Ethernet protocol connection type is an RJ45 jack.

20. The device for transmitting signals from a vehicle of claim 18, wherein the Ethernet protocol connection type is a wireless radio operatively coupled to the controller and configured to transmit an output signal.
